(19) United States
(12) Patent Application Publication
(10) Pub. No.: US 2004/0207245 A1
(43) Pub. Date: Oct. 21, 2004

(54) Seatbelt buckle stabilizing device

(76) Inventor: David M. Baylis, St, Louis, MO (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 10/414,790

(22) Filed: Apr. 16, 2003

(51) Int. Cl. B60R 22/00

(52) U.S. Cl. 297/481

(57) ABSTRACT

A seatbelt buckle stabilizing device for stabilizing a receiving member of a seatbelt buckle. The device is configured to hold the receiving member of a seatbelt buckle at a heightened position from the bottom of a vehicle seat cushion. A channel in the device accepts the receiving member of the seatbelt, thereby stabilizing the receiving member.

### FIELD OF INVENTION

The invention relates to a seatbelt buckle stabilizing device that facilitates buckling of a seatbelt, and more particularly to a seatbelt buckle stabilizing device that stabilizes the receiving member of a seatbelt buckle so that the receiving member remains easily accessible to the seatbelt user.

### BACKGROUND OF THE INVENTION

The use of seatbelts in vehicles is required for protecting the driver and passengers when travelling in a vehicle. In order to ensure the seatbelts are actually utilized it is important that the seatbelts be conveniently located and easily accessible. Vehicles having more than one row of seats behind the front seats are becoming more and more popular, especially with families having small children. This is especially true given the requirements of using car seats or booster car seats with children. These multiple row seats increase the seating options and room available inside vehicles.

A downside to the use of multiple row seats is the awkwardness and inconvenience parents experience when trying to buckle their children into car seats or booster seats using the seatbelts. The receiving member of the seatbelt, that member that accepts the buckle, is typically attached to a loose webbing material so that the receiving member of the seatbelt buckle lies flat on the bottom of the seat cushion. The seatbelt receiving member can be difficult to reach when it is lying in such a position.

The receiving member is usually located between the bottom portion of the seat cushion and the back of the seat cushion. This location can make it difficult to locate and access the receiving member of the seatbelt when trying to lock the seatbelt. The problem can be exasperated when the webbing or the receiving member of the seatbelt becomes lodged between the two portions of the seat cushion and is thereby unaccessible. The problem is further exasperated by the design of children's car seats or booster seats. The design typically includes an undercut on each side of the framework of the seat, which can hide the receiving member of the seatbelt. Currently, it is necessary to use two hands to buckle the seatbelt around the car seat. One hand must locate and access the receiving member of the seatbelt buckle while the other hand is used to fasten the seatbelt.

A further problem with the current design is that children who may be old enough to buckle the seatbelt themselves often cannot reach or see the receiving member of the seatbelt in order to pick it up and hold it in place because it is lying flat on the bottom seat cushion. Also, the child may need to use both hands to buckle the belt and therefore is not able to hold the receiving member of the seatbelt in place. Thus, parents are forced to buckle the child in even when the child is of an appropriate age to do so themselves.

As noted, these seatbelts typically require the use of both hands to fasten the seatbelt. One hand must locate and stabilize the receiving member of the seatbelt while the other hand fastens the seatbelt by inserting the insertion member of the seatbelt into the receiving member. This can be a problem for people who are elderly, arthritic, disabled or have an injury, who may not have the use of both hands in order to buckle the seatbelt.

What is desired for these situations is a device which will stabilize the receiving member of the seatbelt buckle so that it is held in the correct position for interacting with the insertion member of the seatbelt buckle without being held in place manually. The device should also place the receiving member of the seatbelt buckle in a location that is easily accessible.

### SUMMARY OF THE INVENTION

The present invention is a seatbelt buckle stabilizing device for use in a vehicle. The body of the device is configured to hold the receiving member of a seatbelt buckle at a heightened position from the bottom of a vehicle seat cushion, allowing the user to more easily access the receiving member of the seatbelt buckle. The body of the seatbelt buckle stabilizing device has at least one channel which accepts the receiving member of the seatbelt buckle. The channel is thus an appropriate size to accept the receiving member of a seatbelt buckle. The receiving member of the seatbelt buckle can pass through the channel of the seatbelt buckle stabilizing device so that the receiving member is positioned across the top of the device. In one embodiment, the seatbelt buckle stabilizing device is a semi-rigid member.

In another embodiment, the body of the device is a pliable, tubular shape having opposite ends. The opposite ends include securing means for forming a channel. The channel is formed by securing the opposite ends of the body of the device to each other, thus forming a channel around the receiving member of a seatbelt.

The seatbelt buckle stabilizing device can be comprised of any material known in the art which is capable of including at least one channel which a receiving member of a seatbelt buckle can pass through in order to stabilize the receiving member.

### BRIEF DESCRIPTION OF THE DRAWINGS

Attention is now directed to the drawings, where like numerals and characters indicate like or corresponding components. In the drawings

FIG. 1 is a perspective view of a first embodiment of the device in an exemplary use;

FIG. 2 is a perspective view of the first embodiment of the device shown in FIG. 1;

FIG. 3 is a perspective view of the first embodiment of the device shown in FIG. 1;

FIG. 4 is a perspective view of the device shown in FIG. 1;

FIG. 5 is a top view of the device shown in FIG. 1;

FIG. 6 is a perspective view of the device having a single channel;

FIG. 7 is a perspective view of the device shown in FIG. 6;

FIG. 8 is a top perspective view of a third embodiment of the device;

FIG. 9 is a perspective view of the third embodiment of the device shown in FIG. 8;

FIG. 10 is a perspective view of the third embodiment of the device shown in FIG. 9;

FIG. 11 is a perspective view of a fourth embodiment of the device; and

FIG. 12 is a perspective view of the fourth embodiment of the device shown in FIG. 10.

### DETAILED DESCRIPTION OF THE DRAWINGS

The present invention relates to a seatbelt buckle stabilizing device that stabilizes the receiving member of a seatbelt buckle so that the receiving member remains easily accessible to the seatbelt user. The device includes at least one channel which accepts and stabilizes the receiving member of the seatbelt buckle. The seatbelt stabilizing device holds the receiving member in a heightened position above the bottom vehicle seat cushion. By holding the receiving member at a heightened level, the device ensures that the receiving member is easily accessible to a seatbelt user.

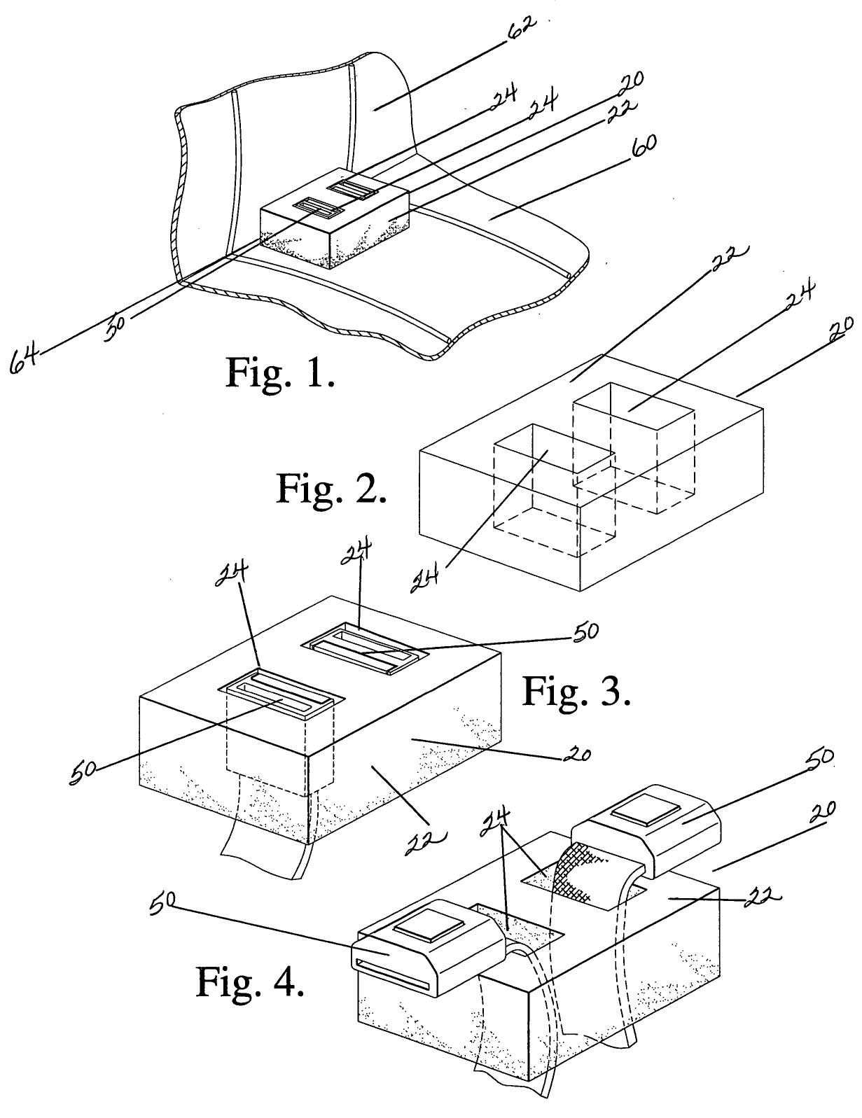

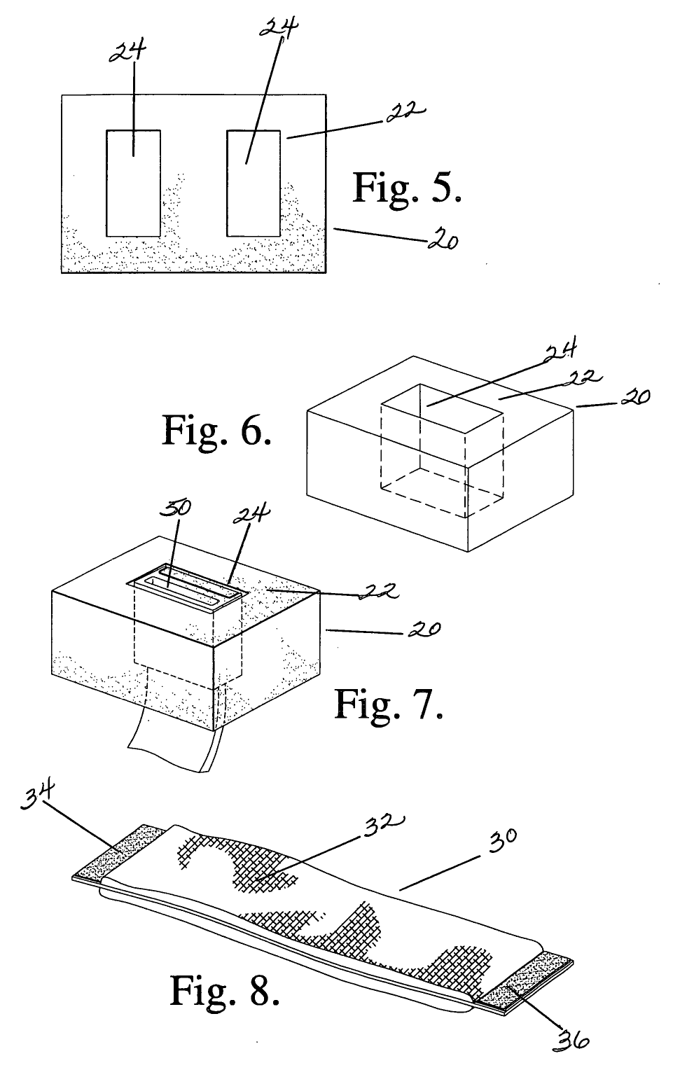

FIGS. 1-3 and 5-7 disclose a first embodiment of a seatbelt buckle stabilizing device 20 for stabilizing a receiving member 50 of a seatbelt buckle. The body 22 of the device is configured to hold the receiving member at a heightened position from the bottom of a vehicle seat cushion 60 so that the receiving member is placed in a position which is easily accessible for a user of the seatbelt. The body can be any shape that is capable of having at least one channel 24 of an appropriate size for accepting a receiving member of a seatbelt buckle. The body is rigid or semi-rigid in this embodiment. The preferred embodiment disclosed in FIGS. 1-3 and 5 includes two such channels. In another embodiment of the device, shown in FIG. 4, the receiving member 50 of the seatbelt buckle passes through the channel 24 of the stabilizing device 20.

The device 20 can be placed on a bottom vehicle seat cushion 60 and against the back of a vehicle seat cushion 62 so that the receiving member of a seatbelt buckle 50 is accepted within the channels 24 of the device, FIG. 1. The receiving member is thus positioned so that it is easily accessible to a seatbelt user. The channel(s) pass through the body 24 of the device as depicted by broken lines in FIGS. 2 and 6. A receiving member 50 of a seatbelt buckle is accepted within the channel, FIGS. 3 and 7 and is thereby held away from the seat cushion in a position that makes it easily accessible for the seatbelt user. Use of this device prevents the receiving member of a seatbelt buckle from slipping into the space 64 between the back vehicle seat cushion 62 and the bottom vehicle seat cushion 60 and thereby becoming inaccessible to a seatbelt user. The device also ensures that the receiving member of the seatbelt buckle does not lie flat against the bottom of the seat cushion.

Any material firm enough to support and thereby stabilize a receiving member can be used for the body of the device. Such materials can include foam material of varying densities, wood, wood by-products, plastic, cloth, fiberglass, rubber, silicon and combinations thereof.

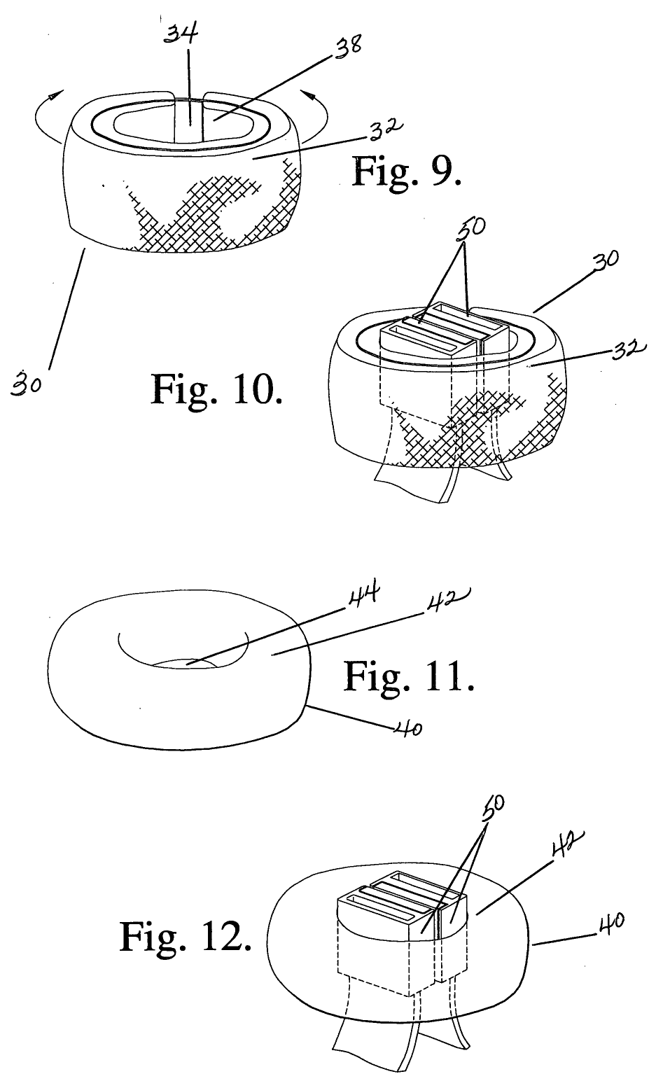

In another embodiment, as disclosed in FIGS. 8-10, the device 30 is a pliable, tubular body 32 of appropriate length to wrap around a receiving member of a seatbelt buckle, FIGS. 8 and 10. The body has a compact, tubular shape of sufficient width to hold the receiving member 50 of a seatbelt buckle at a heightened position from the bottom of a vehicle seat cushion. The body has opposite ends 34 and 36, FIG. 8. Each end includes securing means. The securing means can be any means known in the art, so long as a channel 38 is formed when the opposite ends of the body are secured together, FIGS. 9 and 10. The channel must be of a sufficient size to allow at least one receiving member of a seatbelt buckle to rest within the channel. The securing means can include hooks and loops, buckles, snaps, buttons, zippers, and combinations thereof. The body 32 forms the channel 38 by wrapping around the receiving member 50 of a seatbelt buckle and securing the opposite ends of the body, 34 and 36, together, FIG. 10. Once the device is wrapped around the receiving member, the receiving member is held in a position that makes it easily accessible to a seatbelt user.

The device can be comprised of an outer material and an inner material. These materials can be any materials known in the art which are suitable for such a use. For example, the outer material could be cloth, leather, vinyl, nylon, plastic, soft fiberglass, rubber, silicon, and combinations thereof. The inner material could be cotton, cloth, foam, paper, wood by-products, plastic, rubber, soft fiberglass, silicon, and combinations thereof. The wood by-products could include saw-dust. Plastic could include plastic pellets.

FIGS. 11 and 12 disclose a further embodiment in which the device 40 is a circular, O-shaped body 42 having a channel 44 through its center. The center channel accepts at least one receiving member 50 of a seatbelt buckle, FIG. 12. The center channel holds the receiving members in a position which is easily accessible to a seatbelt user. The device in this embodiment is pliable.

In this embodiment, the device can be comprised of an outer material and an inner material. These materials can be any materials known in the art which are suitable for such a use. For example, the outer material could be cloth, leather, vinyl, nylon, plastic, soft fiberglass, rubber, silicon, and combinations thereof. The inner material could be cotton, cloth, foam, paper, wood by-products, plastic, rubber, soft fiberglass, silicon, and combinations thereof. The wood by-products could include saw-dust. Plastic could include plastic pellets.

Thus, there has been shown and described a seatbelt buckle stabilizing device, which fulfills all the objects and advantages sought therefore. It is apparent to those skilled in the art, however, that many changes, variations, modifications, and other uses and applications for a seatbelt buckle stabilizing device are possible, and also such changes, variations, modifications, and other uses and applications which do not depart from the spirit and scope of the invention are deemed to be covered by the invention, which is limited only by the claims which follow.

1. A seatbelt buckle stabilizing device for stabilizing a receiving member of the seatbelt buckle, said device is comprised of a body configured to hold the receiving member at a heightened position from a bottom of a vehicle seat cushion, said body having at least one channel passing through the entire member, said at least one channel being of an appropriate size to receive and hold the receiving member of the seatbelt buckle.

2. The device of claim 1, wherein said body is comprised of material selected from the groups consisting of foam material, wood, wood by-products, plastic, cloth, fiberglass, rubber, silicon, and combinations thereof.

3. The device of claim 1, wherein said body includes two separate channels for receiving and holding the receiving members of two seatbelt buckles.

4. The device of claim 1, wherein said body is semi-rigid.

5. A device for receiving and holding a receiving member of a seatbelt for use in a vehicle comprised of a body made of material which is slightly pliable, said body having at least one channel through the center portion of the body, said at least one channel being sized to receive and hold the receiving member of a seatbelt buckle.

6. The device of claim 5, wherein said body has at least two channels for receiving and holding the receiving members of at least two seatbelt buckles.

7. A seatbelt buckle stabilizing device for stabilizing a receiving member of the seatbelt buckle, said device is comprised of a pliable, tubular shaped body of sufficient width to hold the receiving member of a seatbelt buckle at a heightened position from a bottom of a vehicle seat cushion, said body further having opposite ends, said opposite ends having securing means, said body further being of an appropriate length to wrap around the receiving member of at least one seatbelt buckle, wherein said opposite ends of said body are secured together by the securing means.

8. The device of claim 7, wherein said body is of an appropriate length to wrap around the receiving members of two seatbelt buckles.

9. The device of claim 7, wherein said device is comprised of an outer material and an inner material.

10. The device of claim 9, wherein the outer material is selected from the group consisting of cloth, leather, vinyl, nylon, plastic, soft fiberglass, rubber, silicon and combinations thereof.

11. The device of claim 9, wherein the inner material is selected from the group consisting of cotton, cloth, foam, paper, wood by-products, plastic, rubber, soft fiberglass, silicon, and combinations thereof.

12. A seatbelt buckle stabilizing device for stabilizing a receiving member of the seatbelt buckle, said device is comprised of a pliable, tubular shaped body of sufficient width to hold the receiving member of a seatbelt buckle at a heightened position from a bottom of a vehicle seat cushion, said body further having opposite ends, said opposite ends having securing means, said body further being of an appropriate length to wrap around the receiving member of at least one seatbelt buckle, wherein said opposite ends of said body are secured together by the securing means, said device further comprises an inner material and an outer material.

13. A seatbelt buckle stabilizing device for stabilizing a receiving member of a seatbelt buckle, said device is comprised of a circular, O-shaped body configured to hold the receiving member at a heightened position from a bottom of a vehicle seat cushion, said body having a channel through the center of said body which receives the receiving member of at least one seatbelt buckle.

14. The device of claim 13, wherein said device is comprised of an outer material and an inner material.

15. The device of claim 14, wherein the outer material is selected from the group consisting of cloth, leather, vinyl, nylon, plastic, soft fiberglass, rubber, silicon, and combinations thereof.

16. The device of claim 14, wherein the inner material is selected from the group consisting of cotton, cloth, foam, paper, wood by-products, plastic, rubber, soft fiberglass, silicon, and combinations thereof.

17. The device of claim 13, wherein said device is pliable.

18. The device of claim 13, wherein said channel is of an appropriate size to accept the receiving members of two seatbelt buckles.

19. A seatbelt buckle stabilizing device for stabilizing a receiving member of a seatbelt buckle, said device is comprised of a circular, O-shaped body configured to hold the receiving member at a heightened position from a bottom of a vehicle seat cushion, said body having a channel through the center of said body which receives the receiving member of at least one seatbelt buckle, said device is pliable and includes an outer material and an inner material.
